(19) United States
(12) Patent Application Publication
(10) Pub. No.: US 2016/0328957 A1
(43) Pub. Date: Nov. 10, 2016

(54) INFORMATION PROCESSING DEVICE AND COMPUTER-READABLE RECORDING MEDIUM

(71) Applicant: FUJITSU LIMITED, Kawasaki-shi (JP)

(72) Inventor: Kouichi MATSUDA, Kawasaki (JP)

(73) Assignee: FUJITSU LIMITED, Kawasaki-shi (JP)

(21) Appl. No.: 15/217,558

(22) Filed: Jul. 22, 2016

Related U.S. Application Data
(63) Continuation of application No. PCT/JP2014/052336, filed on Jan. 31, 2014.

(51) Int. Cl. G08C 19/00

(52) U.S. Cl. CPC G08C 19/00

(57) ABSTRACT

An information processing device includes a main body equipped with a detection sensor and an electronic device that is detachably attachable to the main body using a physical structure. The information processing device determines whether the electronic device is connected to the main body using the physical structure. The information processing device activates output of the detection sensor when the electronic device is connected to the main body using the physical structure. The information processing device inactivates output of the detection sensor when the electronic device is not connected to the main body using the physical structure.

### CROSS-REFERENCE TO RELATED APPLICATION

This application is a continuation of International Application No. PCT/JP2014/052336, filed on Jan. 31, 2014 and designating the U.S., the entire contents of which are incorporated herein by reference.

### FIELD

The embodiments discussed herein are related to an information processing device and a computer-readable recording medium.

### BACKGROUND

Typically, electronic devices equipped with a pyroelectric infrared sensor are known. A pyroelectric infrared sensor captures a phenomenon in which a change in temperature leads to a change in the polarization of a dielectric body; and detects the difference between the heat source and the amount of radiation of background infrared rays. Using such characteristics of the pyroelectric infrared sensor, an electronic device detects a person and automatically starts the operations.

Examples of an electronic device equipped with such a pyroelectric infrared sensor include a television set, an air conditioner, or a lighting equipment. For example, with the aim of reducing the power consumption, a television set detects that the user has left the seat during a television program, and switches OFF the display screen. Moreover, as an anti-crime measure, a lighting equipment switches ON the lighting upon detection of a heat source.

In recent years, a technology is known in which a pyroelectric infrared sensor determines the presence of a person if the absolute temperature exceeding a threshold value is detected on a continuing basis over a given period of time; and, when the room temperature is high, the threshold value is set to be higher than in the normal case so as to prevent malfunctioning from occurring.

Moreover, a technology is known in which, in response to the detection of an operator using a pyroelectric infrared sensor that detects the movements of a person and a reflective sensor that the detects presence of a person, an image processing device is switched from the sleep mode into the operational mode. Furthermore, a technology is known in which the upper part of the detection field of view of an infrared sensor is treated as the detection target and, when no person is present in front of a display device over a predetermined period of time, the display on the display device is turned OFF.

Patent Literature 1: Japanese Laid-open Patent Publication No. 2013-64594

Patent Literature 2: Japanese Laid-open Patent Publication No. 2013-29839

Patent Literature 3: Japanese Laid-open Patent Publication No. 11-231851

However, in the related technologies mentioned above, lot of malfunctioning occurs in an electronic device equipped with a detection sensor such as a pyroelectric infrared sensor. For example, there are times when a detection sensor detects the user leaving the seat after the user has shut down a desktop personal computer using a mouse, and it results in restarting the desktop personal computer.

Moreover, in a personal computer in which the main body and the display are detachably attachable to each other, even when the display is docked out and the personal computer is not in use, if a detection sensor installed in the main body detects a person or an animal, the main body of the personal computer is activated. In that case, the electrical power supply to the display is also turned ON. However, if the display is kept on a bed or the like, the accumulation of heat increases the risk of heating.

### SUMMARY

According to an aspect of an embodiment, an information processing device includes; a main body equipped with a detection sensor; an electronic device that is detachably attachable to the main body using a physical structure; and a processor that executes a process. The process includes determining whether the electronic device is connected to the main body using the physical structure; activating output of the detection sensor when the electronic device is connected to the main body using the physical structure, and inactivating output of the detection sensor when the electronic device is not connected to the main body using the physical structure.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an exemplary overall configuration of an information processing device;

FIG. 2 is a block diagram illustrating a configuration of the information processing device;

FIG. 3 is a diagram for explaining the changes in the output voltage of a pyroelectric infrared sensor;

FIG. 4 is a flowchart for explaining an overall flow of operations during a main body activation operation performed using the pyroelectric infrared sensor;

FIG. 5 is a flowchart for explaining a flow of operations up to human detection during the main body activation operation; and

FIG. 6 is a diagram for explaining a detection area.

### DESCRIPTION OF EMBODIMENTS

Preferred embodiments will be explained with reference to accompanying drawings. However, the present invention is not limited by these embodiments.

### [a] First Embodiment

### Overall Configuration

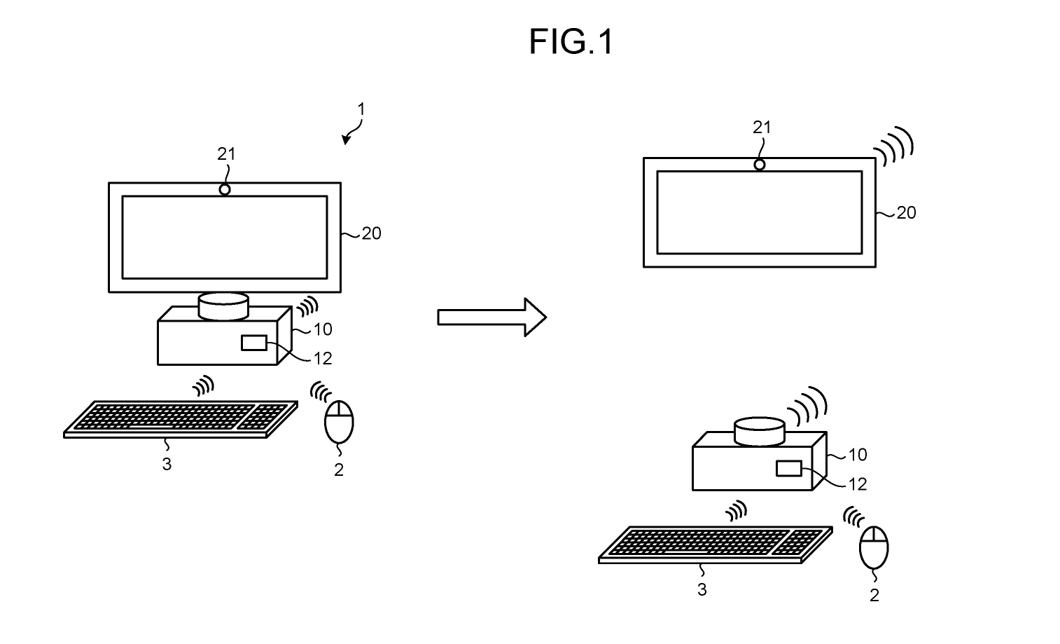

FIG. 1 is a diagram illustrating an exemplary overall configuration of an information processing device. As illustrated in FIG. 1, an information processing device 1 includes a mouse 2, a keyboard 3, a main body 10, and a detachably-attachable display 20. The main body 10 and the detachably-attachable display 20 are configured to be detachably attachable to each other using a physical docking structure. The mouse 2 and the keyboard 3 represent examples of an input device for receiving input operations from the user.

The main body 10 is a processor that includes a memory and a processor, and that performs various operations. Moreover, the main body 10 includes a pyroelectric infrared sensor 12 that detects a heat source. The pyroelectric infrared sensor 12 captures a phenomenon in which a change in temperature leads to a change in the polarization of a dielectric body, and is used to detect a person using the difference between the heat source and the amount of radiation of background infrared rays.

The detachably-attachable display 20 is a touch-sensitive panel display that is detachably attachable to the main body 10, and includes an illuminance sensor 21. Herein, the illuminance sensor 21 detects the ambient illuminance of the detachably-attachable display 20.

Meanwhile, each electronic device is equipped with the wireless communication function. Thus, the information operated using the mouse 2 or the keyboard 3 is received by the main body 10 using wireless communication. Then, the main body 10 implements the operations received from the mouse 2.

The detachably-attachable display 20 sends information, which is received on the touch-sensitive panel thereof, to the main body 10 using wireless communication. Then, the main body 10 performs operations corresponding to the information received from the detachably-attachable display 20, and sends information to the detachably-attachable display 20. Subsequently, the detachably-attachable display 20 displays the information received from the main body 10.

In the information processing device 1, the main body 10 determines whether the detachably-attachable display 20 is connected thereto using a physical structure. If it is determined that the connection is established, then the main body 10 activates the output of the pyroelectric infrared sensor 12. On the other hand, if it is determined that the connection is not established, the main body 10 inactivates the output of the pyroelectric infrared sensor 12.

For example, after the operating system (OS) has been switched to the standby state, if the pyroelectric infrared sensor 12 detects a person, the main body 10 switches ON a power supply circuit and reboots the OS. At the start of this operation, the main body 10 determines whether or not the detachably-attachable display 20 is docked thereto. If the detachably-attachable display 20 is docked, the main body 10 enables the output of the pyroelectric infrared sensor 12 to “ON” and starts human detection.

In this way, in the information processing device 1, in the case of booting the OS using the pyroelectric infrared sensor 12 installed in the main body 10, the output of the pyroelectric infrared sensor 12 is disabled until the detachably-attachable display 20 is docked. That enables achieving reduction in malfunctioning.

### Configuration of Information Processing Device

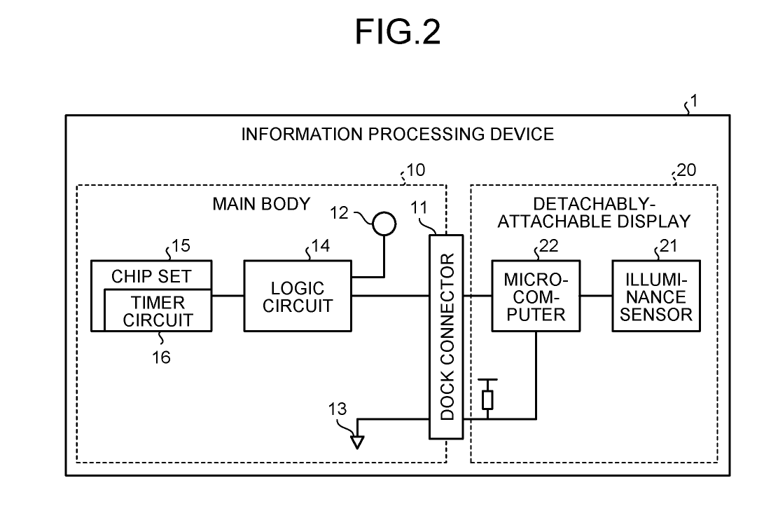

FIG. 2 is a block diagram illustrating a configuration of the information processing device. As illustrated in FIG. 2, the information processing device 1 includes the main body 10 and the detachably-attachable display 20. Meanwhile, the mouse 2 and the keyboard 3 illustrated in FIG. 1 have identical functions to a general-purpose wireless mouse and a general-purpose wireless keyboard. Hence, herein, the detailed explanation is not given.

The main body 10 includes a dock connector 11, the pyroelectric infrared sensor 12, ground 13, a logic circuit 14, and a chip set 15. The dock connector 11 is a connector unit of the main body 10 and has a docking structure. As a result of docking between the dock connector 11 and the detachably-attachable display 20, the main body 10 and the detachably-attachable display 20 get physically connected to each other.

The pyroelectric infrared sensor 12 is a sensor unit used for human detection. When an instruction to start the detection is received from the logic circuit 14, the pyroelectric infrared sensor starts outputting infrared rays. Then, the pyroelectric infrared sensor 12 outputs the output result to the logic circuit 14 as needed. The ground 13 represents the reference potential that is set to the voltage of 0 V, for example.

The logic circuit 14 is a circuit unit that detects the output of the pyroelectric infrared sensor 12 and detects the attached-detached state or the detachably-attachable display 20. Herein, the logic circuit 14 represents an example of a determining unit and an output control unit mentioned in claims.

More particularly, the logic circuit 14 determines whether or not the detachably-attachable display 20 is docked to the dock connector 11. If it is determined that docking is done, then the logic circuit 14 enables the output of the pyroelectric infrared sensor 12. However, if it is determined that docking is not yet done, the logic circuit 14 disables the output of the pyroelectric infrared sensor 12.

For example, when the detachably-attachable display 20 is docked, the logic circuit 14 performs control to enable the output of the pyroelectric infrared sensor 12, and receives the detection result from the pyroelectric infrared sensor 12. When the detection result from the pyroelectric infrared sensor 12 indicates that a person is detected, if the illuminance value detected by the illuminance sensor 21 is equal to or greater than a predetermined value, the logic circuit 14 instructs the chip set 15 to boot the OS.

The chip set 15 is a controller that controls the booting of the OS, and includes a timer circuit 16. More particularly, when an OS booting instruction is received from the logic circuit 14, the chip set 15 turns ON the power and starts OS operations.

Herein, when an OS booting instruction is received from the logic circuit 14, the chip set 15 starts the timer circuit 16. Then, if a person is detected on a continuing basis over a predetermined period of time, the chip set 15 starts OS operations.

The detachably-attachable display 20 is a display including the illuminance sensor 21 and a microcomputer 22, and represents an example of an electronic device mentioned in claims. The illuminance sensor 21 is a sensor for detecting the illuminance of the detachably-attachable display 20, and outputs the detected illuminance value to the microcomputer 22.

The microcomputer 22 is a microcomputer unit that receives the output of the illuminance sensor 21 and reports it to the chip set 15. For example, the microcomputer 22 receives the illuminance value from the illuminance sensor 21, and outputs it to the chip set 15 via the dock connector 11 and the logic circuit 14.

Given below is the explanation about the flow of signals and voltage changes in the information processing device 1. When the detachably-attachable display 20 is docked to the dock connector 11, a voltage (DOCK_DET#) inside the detachably-attachable display 20 is drawn toward the voltage of the ground 13 and thus drops to a low level.

As a result, the voltage between the microcomputer and the logic circuit 14 drops to a low level, and consequently the docking of the detachably-attachable display 20 is detected. Then, the logic circuit 14 performs control to enable the output of the pyroelectric infrared sensor 12.

Meanwhile, when the output of the illuminance sensor 21 becomes stable and the detected illuminance value is equal to or greater than a predetermined value, the microcomputer 22 determines that the periphery of the detachably-attachable display 20 is bright and outputs a signal (AMB_HIGH=HIGH (ambient brightness=bright)) to the logic circuit 14. However, if the detected illuminance value is smaller than the predetermined value, then the microcomputer 22 determines that the periphery of the detachably-attachable display 20 is dark and outputs a signal (AMB_HIGH=LOW (ambient brightness=dark)) to the logic circuit 14.

In this way, when the signal (AMB_HIGH=HIGH) is received from the microcomputer 22, the logic circuit 14 detects that the ambient brightness of the detachably-attachable display 20 is high. In that state, if the detection result of the pyroelectric infrared sensor 12 indicates that a person is detected, the logic circuit 14 instructs the chip set 15 to start OS operations.

### Changes in Output Voltage of Pyroelectric Infrared Sensor

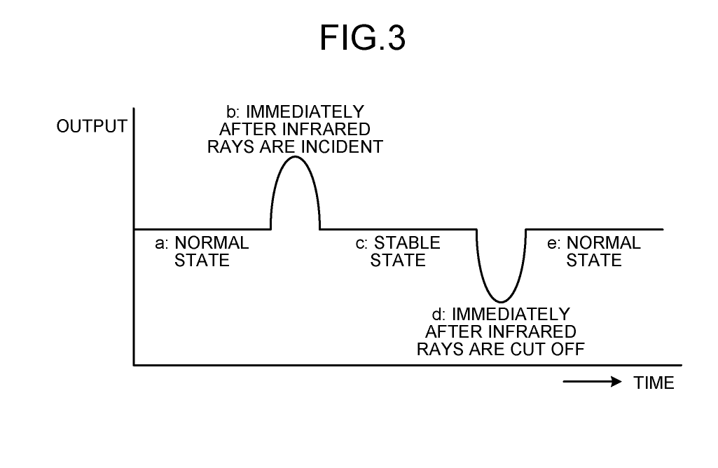

FIG. 3 is a diagram for explaining the changes in the output voltage of the pyroelectric infrared sensor. In FIG. 3, “a” represents a normal state in which there are no changes in the environment. Hence, the output voltage of the pyroelectric infrared sensor 12 becomes constant.

In FIG. 3, “b” represents a state which is attained immediately after the infrared rays are incident and in which a temperature change in the environment is detected, and it is detected that a heat source has come closer. As a result, there is an increase in the output voltage of the pyroelectric infrared sensor 12. From the change in the output voltage during the state “b” illustrated in FIG. 3, the logic circuit 14 detects that a person has moved closer.

In FIG. 3, “c” represents a stable state over a stable period during which, after a temperature change was detected, there is no more change in the temperature; and the output voltage of the pyroelectric infrared sensor 12 becomes constant. That is, the logic circuit 14 keeps on detecting a person on a continuing basis since the state “b” illustrated in FIG. 3.

In FIG. 3, “d” represents the state which is attained immediately after the infrared rays are cut off and in which a temperature change is captured that is attributed to the moving away of the heat source from the detection area. That results in a significant change in the output voltage of the pyroelectric infrared sensor 12. From the change in the output voltage occurring in the state “d” illustrated in FIG. 3, the logic circuit 14 detects that the person detected in the state “b” illustrated in FIG. 3 has moved away. In FIG. 3, “e” represents a return to the same state as the state “a” illustrated in FIG. 3.

### Overall Flow of Operations

Given below is the explanation of the operations performed in the information processing device 1. Herein, as an example, the explanation is given for a case in which, after the detachably-attachable display 20 of the information processing device 1 has been docked out, the OS is restored from the sleep mode using the pyroelectric infrared sensor 12. In other words, the explanation is given about activating the main body 10 from the sleep mode in response to human detection by the pyroelectric infrared sensor 12.

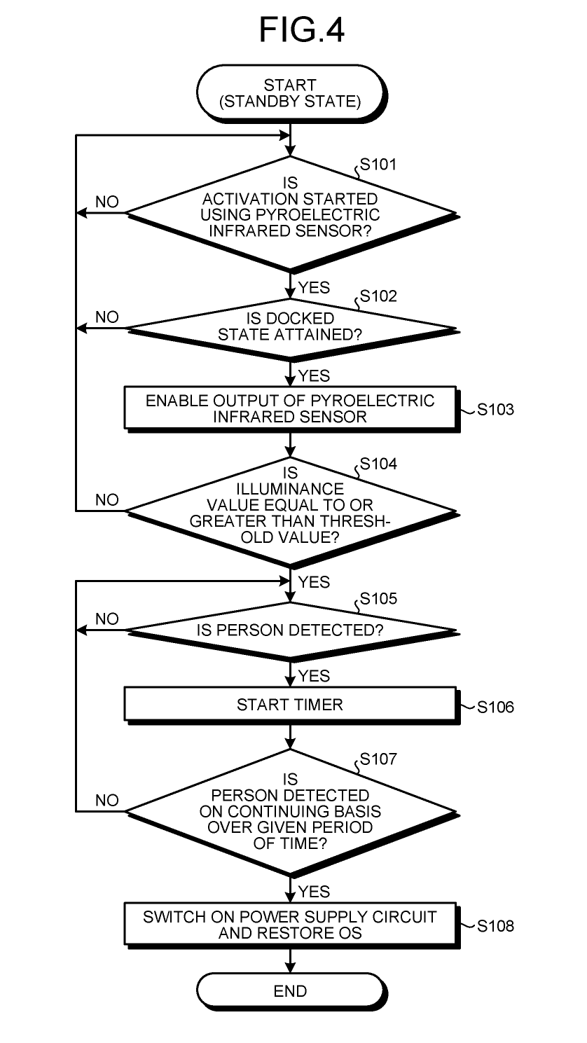

FIG. 4 is a flowchart for explaining an overall flow of operations during a main body activation operation performed using the pyroelectric infrared sensor. As illustrated in FIG. 4, when the chip set 15 of the main body 10 starts activation using the pyroelectric infrared sensor 12 (Yes at S101), the logic circuit 14 of the main body 10 determines whether or not the detachably-attachable display 20 is in the docked state (S102). For example, after the elapse of a predetermined period of time since switching to the sleep mode, the chip set 15 automatically starts the operations.

If the detachably-attachable display 20 is determined to be in the docked state (Yes at S102), the logic circuit 14 enables the output of the pyroelectric infrared sensor 12 (S103). That is, the logic circuit 14 performs control to enable the output of the pyroelectric infrared sensor 12.

Moreover, the logic circuit 14 determines whether or not the illuminance value detected by the illuminance sensor 21 of the detachably-attachable display 20 is equal to or greater than a threshold value (S104). Herein, either the operation at S103 or the operation at S104 can be performed first.

If the illuminance value detected by the illuminance sensor 21 is equal to or greater than the threshold value (Yes at S104), when a person is detected according to a change in the output voltage of the pyroelectric infrared sensor 12 (Yes at S105), the logic circuit 14 starts the timer of the timer circuit 16 (S106).

If it is determined that the person is detected by the logic circuit 14 on a continuing basis over a given period of time (Yes at S107), then the chip set 15 switches ON the power supply circuit and restores the OS (S108). However, at S107, if a person is not detected on a continuing basis (No at S107), the logic circuit 14 repeatedly performs the operations from S105 onward.

Meanwhile, at S104, if the illuminance value detected by the illuminance sensor 21 is smaller than the threshold value (No at S104), then the system control returns to S101 and the logic circuit 14 repeatedly performs the operations from S101 onward. Similarly, at S102, if it is determined that the detachably-attachable display 20 is not in the docked state (No at S102), then the system control returns to S101 and the logic circuit 14 repeatedly performs the operations from S101 onward.

### Flow from Illuminance Sensor to Human Detection

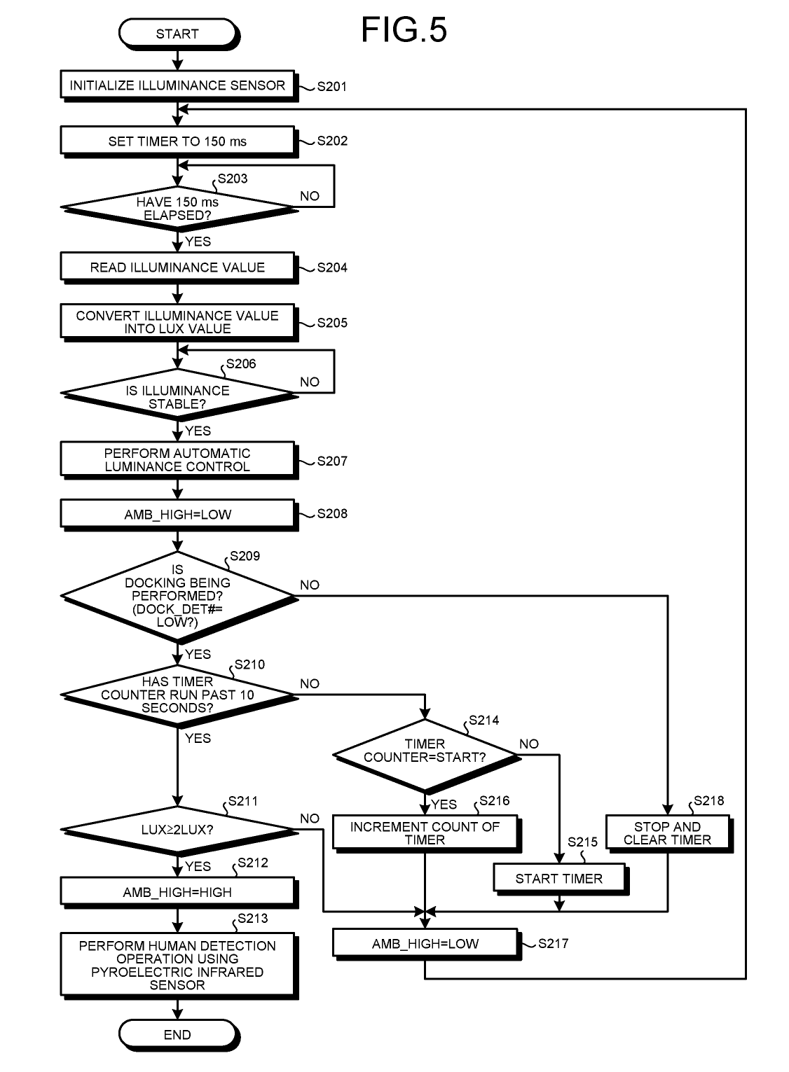

FIG. 5 is a flowchart for explaining a flow of operations up to human detection during the main body activation operation. As illustrated in FIG. 5, after the start of operations, the microcomputer 22 of the detachably-attachable display 20 initializes the illuminance sensor (S201).

Then, the microcomputer 22 sets the timer to 150 ms, for example, and starts the timer (S202). After the elapse of 150 ms (Yes at S203), the microcomputer 22 reads the illuminance value (S204). That is, the microcomputer 22 obtains, from the illuminance sensor 21, illuminance data detected by the illuminance sensor 21.

Subsequently, the microcomputer 22 converts the illuminance value into a lux value (S205) and determines whether or not the illuminance has become stable (S206). For example, the microcomputer 22 determines whether or not an ambient light sensing (ALS) counter has exceeded a threshold value (6×(150×6=900 ms)).

When it is determined that the illuminance has become stable (Yes at S206), the microcomputer 22 performs automatic luminance control with respect to the background brightness of the detachably-attachable display 20 (S207). For example, the microcomputer 22 controls the brightness of the detachably-attachable display 20 to an appropriate brightness in accordance with the room brightness.

Then, the microcomputer 22 sets the signal (AMB_HIGH) to “LOW” (S208) and determines whether or not the detachably-attachable display 20 is being docked (S209). For example, the microcomputer 22 determines whether or not the signal line to which the microcomputer 22 is connected has dropped to a low level.

If it is determined that the detachably-attachable display 20 is being docked (Yes at S209), then the microcomputer 22 determines whether or not the timer counter has run past 10 seconds (S210).

If the timer counter has run past 10 seconds (Yes at S210), when the total of the lux values obtained till then is equal to or greater than twice the initial lux value (S211), the microcomputer 22 sets the signal (AMB_HIGH) to “HIGH” (S212).

Then, the microcomputer 22 sends the signal (AMB_HIGH=HIGH) to the logic circuit 14, so that the logic circuit 14 starts a human detection operation using the pyroelectric infrared sensor 12 (S213).

Meanwhile, if the timer counter is within 10 seconds (No at S210) and if the timer counter is not at “START” (No at S214), then the microcomputer 22 starts the timer (S215).

On the other hand, if the timer counter is within 10 seconds (No at S210) but if the timer counter is at “START” (Yes at S214), then the microcomputer 22 increments the count of the timer (S216).

After the operation at S215 or S216, the microcomputer 22 sets the signal (AMB_HIGH) to “LOW” (S217) and repeatedly performs the operations from S202 onward. Meanwhile, at S209, if it is determined that the detachably-attachable display 20 is not being docked (No at S209), the microcomputer 22 stops the timer and clears it (S218), sets the signal (AMB_HIGH) to “LOW” (S217), and repeatedly performs the operations from S202 onward.

### Effect

As described above, the information processing device 1 includes the main body 10 and the detachably-attachable display 20. Moreover, as a result of having the illuminance sensor for detecting the operable state based on the ambient brightness, at the time of determining the docking state, it becomes possible to prevent malfunctioning.

Moreover, in the information processing device 1, as a result of combining the pyroelectric infrared sensor 12 and the timer circuit 16, when a person is detected but becomes undetectable within few seconds, it becomes possible to perform control in which it is determined that the person does not wish the information processing device 1 to start and that the person only passed by the information processing device 1, and the information processing device 1 is not activated.

Furthermore, in the information processing device 1, when a signal indicating that a person is detected but becomes undetectable in few seconds is not received, it becomes possible to perform control in which it is determined that the person is present in front of the information processing device 1 and wishes the information processing device 1 to start, and the information processing device 1 or the OS is booted.

In this way, in the information processing device 1, the case in which a person wishes to use the information processing device 1 is correctly determined, and the information processing device 1 is activated only in that case. That enables prevention of malfunctioning. Moreover, since malfunctioning is prevented, it also leads to a decrease in the power consumption. Furthermore, in the information processing device 1, since malfunctioning can be prevented by reusing the existing configuration, it becomes possible to prevent malfunctioning using inexpensive circuitry.

For example, in the information processing device 1, when the detachably-attachable display 20 is docked out and is not in use, the pyroelectric infrared sensor 12 installed in the main body 10 can be prevented from detecting a person. As a result, it becomes possible to save the battery of the detachably-attachable display 20, and to prevent malfunctioning such as a thermal runaway phenomenon due to heating attributed to automatic activation of the detachably-attachable display 20.

Moreover, in the information processing device 1, in the dark environment at bedtime, the pyroelectric infrared sensor 12 can be prevented from detecting a heat source attributed to roll-over or a pet, thereby enabling to hold down the power consumption. Furthermore, in the case of using the information processing device 1 as a normal desktop personal computer, when the personal computer is switched to the sleep mode or is shut down by the user before leaving the seat, it is possible to prevent detection of the action of leaving the seat.

### [b] Second Embodiment

Meanwhile, although the present invention has been described with reference to the abovementioned embodiment, it is also possible to implement the invention in various forms other than the abovementioned embodiment.

### Detection Area of Pyroelectric Infrared Sensor

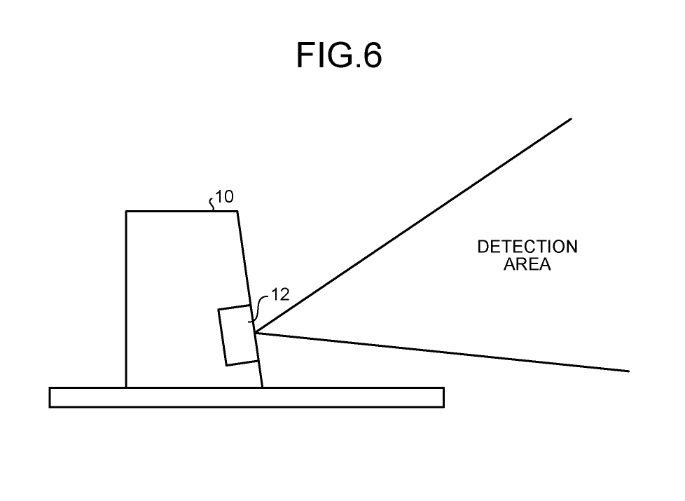

For example, regarding the output area of the pyroelectric infrared sensor 12 installed in the main body 10, the upper direction with respect to the horizontal plane on which the main body 10 is installed can be treated as the detection target. FIG. 6 is a diagram for explaining the detection area. As illustrated in FIG. 6, in a situation in which the main body 10 is placed on a table, the output range of the pyroelectric infrared sensor 12 is controlled to be at an upper level than the table. With that, the detection area by the pyroelectric infrared sensor 12 gets set above the table. Hence, it becomes possible to prevent detection of a pet dog or a pet cat, and to prevent detection of roll-over during sleep.

### Electronic Device

In the embodiment described above, the explanation is given for an example of determining whether or not the detachably-attachable display 20 is in the docked state. However, that is not the only possible case. Alternatively, for example, regarding a detachably-attachable electronic device other than the display, the main body 10 can perform determination in an identical manner and control the output of the pyroelectric infrared sensor 12.

Moreover, in the information processing device 1, it can be determined whether or not each of a plurality of detachably-attachable electronic devices is in the docked state and, when all detachably-attachable electronic devices are in the docked state or when particular detachably-attachable electronic devices are in the docked state, control can be performed to enable the output of the pyroelectric infrared sensor 12.

### Pyroelectric Infrared Sensor

In the embodiment described above, the explanation is given for an example in which the pyroelectric infrared sensor 12 is used. However, that is not the only possible case. Alternatively, it is also possible to use a proximity sensor, which is a contactless sensor that releases energy in the form of a magnetic field, electromagnetic waves, light, or sound waves and captures the changes in the material or energy after reflection. Using the changes in the energy detected by the proximity sensor, the logic circuit 14 detects that a person has moved closer.

### System Configuration

Meanwhile, the constituent elements of the devices illustrated in the drawings are merely conceptual, and need not be physically configured as illustrated. The constituent elements, as a whole or in part, can be separated or integrated either functionally or physically based on various types of loads or use conditions. Moreover, all or some of the operational functions implemented in the constituent elements can be implemented using a CPU and using computer programs analyzed and executed by the CPU, or can be implemented using hardware such as a wired logic.

Of the processes described in the embodiment, the whole or a part of the processes that are mentioned as being automatically performed can also be manually performed, or the whole or a part of the processes that are mentioned as being manually performed can also be automatically performed using known methods. Furthermore, the flow of the processes, the control procedures, the specific names, and the information containing various kinds of data or parameters indicated in the above specification and drawings can be arbitrarily changed unless otherwise stated.

Meanwhile, the information processing device 1 according to the embodiments can read a sensor output control program and execute it so as to implement identical functions to the operations explained with reference to FIG. 2. For example, the information processing device 1 can execute processes for carrying out the determination operation performed by the logic circuit 14 and the OS booting operation performed by the chip set 15, and can perform operations identical to the embodiments described above. The sensor output control program can be distributed via a network such as the Internet. Alternatively, the sensor output control program can be recorded in a computer-readable recording medium such as a flexible disk (FD), a compact disk read only memory (CD-ROM), a magneto optical (MO) disk, or a digital versatile disk (DVD). Then, a computer can read the sensor output control program from the recording medium and execute it.

An information processing device and a computer-readable recording medium disclosed in the application concerned enable achieving reduction in malfunctioning.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing device comprising:
a main body equipped with a detection sensor;
an electronic device that is detachably attachable to the main body using a physical structure; and
a processor that executes a process including:
determining whether the electronic device is connected to the main body using the physical structure;
activating output of the detection sensor when the electronic device is connected to the main body using the physical structure, and
inactivating output of the detection sensor when the electronic device is not connected to the main body using the physical structure.

2. The information processing device according to claim 1, wherein
the electronic device is equipped with an illuminance sensor that detects illuminance around the electronic device, and
the main body suppresses start of operations of the information processing device when the electronic device is connected to the main body using the physical structure and when illuminance value detected by the illuminance sensor is smaller than a predetermined value.

3. The information processing device according to claim 1, wherein, after output of the detection sensor is activated, when the detection sensor detects a person on a continuing basis over a predetermined period of time, the main body starts operations of the information processing device.

4. The information processing device according to claim 1, wherein the detection sensor treats, as detection target, upper direction with respect to horizontal plane on which the main body is installed.

5. The information processing device according to claim 1, wherein the detection sensor is either a pyroelectric infrared sensor that detects a heat source or a proximity sensor that detects an object.

6. A non-transitory recording medium having stored therein a sensor output control program that causes a computer to execute a process comprising:
determining whether an electronic device that is detachably attachable to a main body using a physical structure is connected to the main body equipped with a detection sensor using the physical structure;
activating output of the detection sensor when the electronic device is connected to the main body using the physical structure, and
inactivating output of the detection sensor when the electronic device is not connected to the main body using the physical structure.
